(19) United States
(12) Patent Application Publication
(10) Pub. No.: US 2020/0184467 A1
(43) Pub. Date: Jun. 11, 2020

(54) SYSTEM AND METHOD FOR PROVIDING A SECURE TRANSACTION NETWORK

(71) Applicant: MobileCoin, San Francisco, CA (US)

(72) Inventors: Suresh Toby SEGARAN, San Francisco, CA (US); Joshua GOLDBARD, Berkeley, CA (US); Balabhadra "Alex" GRAVELEY, San Francisco, CA (US)

(21) Appl. No.: 16/213,956

(22) Filed: Dec. 7, 2018

(51) Int. Cl. G06Q 20/36; G06Q 20/02; G06Q 20/32; G06Q 20/38

(52) U.S. Cl. CPC G06Q 20/3678; G06Q 20/027; G06Q 2220/00; G06Q 20/3829; G06Q 20/3825; G06Q 20/322

(57) ABSTRACT

A system and method for providing a secure transaction network are disclosed. A particular embodiment includes: a plurality of network nodes in data communication with each other via a network, each network node having a secure processing enclave, the enclave configured to include: at least one isolated memory device, processing logic isolated from operating system (OS) calls, and a remote attestation capability; and a wallet configured as executable code on a client device, the wallet including a view key and a spend key, the wallet configured to establish a secure data communication with at least one of the plurality of network nodes, the secure data communication being enabled after the enclave of the at least one of the plurality of network nodes is validated after completion of the remote attestation.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2017-2018, MobileCoin, All Rights Reserved.

### TECHNICAL FIELD

This patent document pertains generally to online payment systems, secure online digital delivery systems, and more particularly, but not by way of limitation, to a system and method for providing a secure transaction network.

### BACKGROUND

Digital currency, crypto-currency, and blockchain technologies have been developed to facilitate the secure transfer of online payments. These technologies use encrypted keys and sophisticated decentralized data structures or blockchains to record and validate transactions across a network of distributed computing nodes. The blockchain for a particular implementation must be constantly synchronized between the distributed computing nodes to assure security and validity of the payment and transaction data. The blockchain synchronization, key management, and transaction handling can consume a significant level of processing capacity and device resources on the computing nodes. In many conventional implementations, a trusted third party service is used to manage keys and validate transactions. However, the third party service can be vulnerable to being compromised thereby destroying the security of the online payment system. Moreover, the processing loads and resource demands on the computing nodes can overwhelm the nodes thereby slowing transaction times, causing latency, and producing an unacceptable user experience. The situation is exacerbated when mobile applications or mobile devices are used as mobile applications typically don't have the ability or capacity to synchronize an entire multi-gigabyte blockchain. Mobile applications can produce minutes-long transaction times, which are unacceptable for typical use cases. Additionally, mobile device end users are not typically equipped to reliably maintain secret keys over a long period of time. As a result, conventional digital currency, crypto-currency, and blockchain technologies are unable to support secure, efficient, rapid, and user-friendly secure transactions, especially on mobile applications or mobile devices.

### SUMMARY

A system and method for providing a secure transaction network are disclosed. The secure transaction network system of an example embodiment can be deployed, in a particular implementation, as a payment system designed to be used by network user/consumers. In various example embodiments, users on mobile devices and mobile applications can use the disclosed secure transaction network system without unacceptable latency or compromised security. Several important design principles of the secure transaction network system disclosed herein include simplicity, speed, and security. All of these principles are addressed with complex technical systems that are hidden beneath great user experiences. The network users don't have to understand how the secure transaction network system works to use the system effectively. Another important design principle of the secure transaction network system is user privacy. The disclosed embodiments enable users to control their data and make meaningful choices about their data and the use thereof.

When the secure transaction network system of an example embodiment is deployed as a payment system, secure transactions can be initiated by users to transfer digital cash between users. Just like paper money, digital cash requires a wallet. As disclosed herein, a wallet is a software module configured to manage a user's digital cash. A wallet enables a user to send and receive digital cash via the secure transaction network system. In some implementations, the wallet can be configured to execute and manage a user's digital cash on a mobile device. However, in other implementations, the wallet can be configured to execute on a mobile device while managing and storing the user's digital cash through financial institutions. Unlike paper money, digital cash can be sent over a data network (e.g., the Internet) via the secure transaction network system to any other user's wallet. When a user transfers digital cash to another user's wallet using the secure transaction network system disclosed herein, the only record of the transaction is in the sender user's wallet and in the receiver user's wallet. In particular, the sender has an entry in their wallet indicating that they spent digital cash; but, the sender does not retain a specific record of where the digital cash was sent. Similarly, the receiver has an entry in their wallet indicating that they received digital cash; but, the receiver does not retain a specific record detailing from where the digital cash was received. As a result, the anonymity of the transaction is preserved.

In an example embodiment of the secure transaction network system, a user can configure their wallet to manage where and how the transaction records for a particular user are stored or backed up. In particular, the secure transaction network system does not keep any identifying records of a user's transactions. However, every user can use their wallet to configure the type of information to store for the particular user. In various example embodiments, user wallets can be configured with a variety of privacy settings to accommodate various levels of user data privacy. Further details of various example embodiments of the secure transaction network system are provided below with reference to the figures provided herewith.

### BRIEF DESCRIPTION OF THE DRAWINGS

The various embodiments are illustrated by way of example, and not by way of limitation, in the figures of the accompanying drawings in which:

FIG. 1 illustrates an example embodiment of a secure transaction network ecosystem in which an example embodiment can be implemented;

FIGS. 2 through 6 illustrate an example embodiment of a system and method for establishing a secure channel in the secure transaction network;

FIGS. 7 through 9 illustrate an example embodiment of a system and method for retrieving transaction outputs in the secure transaction network;

FIGS. 10 through 12 illustrate an example embodiment of a system and method for determining spent transaction outputs in the secure transaction network;

FIGS. 13 through 15 illustrate an example embodiment of a system and method for retrieving additional transactions for ring signature in the secure transaction network;

FIGS. 16 through 19 illustrate an example embodiment of a system and method for generating a transaction in the secure transaction network;

FIGS. 20 through 25 illustrate an example embodiment of the interaction between network nodes for processing secure transactions in the secure transaction network;

FIG. 26 illustrates an example embodiment of a system and method for enabling a client device to view spendable transactions in the secure transaction network;

FIG. 27 illustrates an example embodiment of the information maintained in the transaction ledger in the secure transaction network; and

FIG. 28 is a processing flow chart illustrating an example embodiment of a system and method for providing a secure transaction network.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

A system and method for providing a secure transaction network are disclosed. The secure transaction network system of an example embodiment can be deployed, in a particular implementation, as a payment system designed to be used by network user/consumers. In various example embodiments, users on mobile devices and mobile applications can use the disclosed secure transaction network system without unacceptable latency or compromised security.

When the secure transaction network system of an example embodiment is deployed as a payment system, secure transactions can be initiated by users with wallets to transfer digital cash between users. As disclosed herein, a wallet is a software module configured to manage a user's digital cash. A wallet enables a user to send and receive digital cash via the secure transaction network system. In some implementations, the wallet can be configured to execute and manage a user's digital cash on a mobile device. However, in other implementations, the wallet can be configured to execute on a mobile device while managing and storing the user's digital cash through financial institutions. Unlike paper money, digital cash can be sent over a data network (e.g., the Internet) via the secure transaction network system to any other user's wallet. When a user transfers digital cash to another user's wallet, the only record of the transaction is in the sender user's wallet and in the receiver user's wallet. In particular, the sender has an entry in their wallet indicating that they spent digital cash; but, the sender does not retain a specific record of where the digital cash was sent. Similarly, the receiver has an entry in their wallet indicating that they received digital cash; but, the receiver does not retain a specific record of from where the digital cash was received. As a result, the anonymity of the transaction is preserved.

In an example embodiment of the secure transaction network system, a user can configure their wallet to manage where and how the transaction records for a particular user are stored or backed up. In particular, the secure transaction network system does not keep any identifying records of a user's transactions. However, every user can use their wallet to configure the type of information to store for the particular user. In various example embodiments, user wallets can be configured with a variety of privacy settings to accommodate various levels of user data privacy. Further details of various example embodiments of the secure transaction network system are provided below with reference to the figures provided herewith.

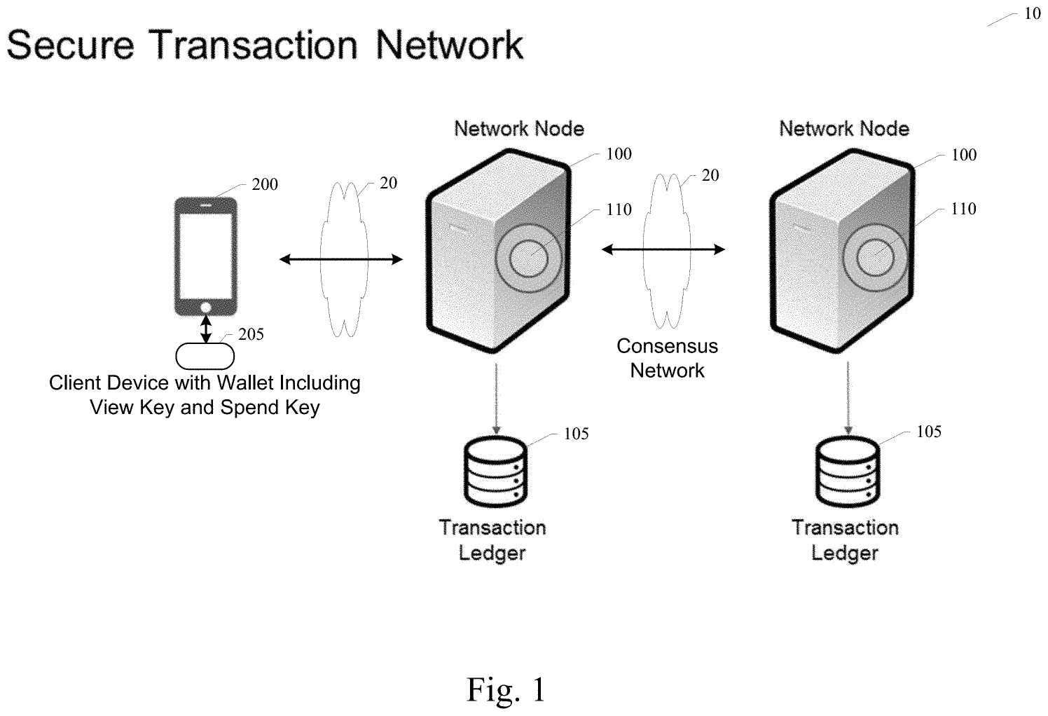

Referring now to FIG. 1, an example embodiment of a secure transaction network ecosystem 10 in which an example embodiment can be implemented is illustrated. As shown in FIG. 1, the secure transaction network ecosystem 10 can include a plurality of distributed computing nodes or network nodes 100 in networked data communication with each other via network 20. The secure transaction network ecosystem 10 can also include a plurality of user or client platforms or client devices 200 in networked data communication with one or more of the network nodes 100 via network 20. Each client device 200 can include a wallet 205, which is a software component executing within the client device 200.

Network 20 can be configured to couple one computing device/node with another computing device/node in networked data communication. Network 20 may be enabled to employ any form of computer readable media for communicating information from one electronic device to another. For example, network 20 can include the Internet, other wide area networks (WANs), local area networks (LANs), direct connections, such as through a universal serial bus (USB) port, wireless data connections (e.g., WiFi, Bluetooth™, etc.), optic data connections, other forms of devices for the transfer of computer-readable media, or any combination thereof. On an interconnected set of sub-networks, including those based on differing architectures and protocols, a router and/or gateway device can act as a link between sub-networks, enabling messages to be sent between computing devices/nodes in a network ecosystem.

Network 20 may further include any of a variety of wireless sub-networks that may further overlay stand-alone or ad-hoc networks to provide an infrastructure-oriented connection. Such sub-networks may include mesh networks, wireless LAN (WLAN) networks, cellular networks, and the like. Network 20 may also include an autonomous system of terminals, gateways, routers, and the like connected by wireless radio links or wireless transceivers. These connectors may be configured to move freely and randomly and organize themselves arbitrarily, such that the topology of network 20 may change rapidly and arbitrarily.

Network 20 may further employ a plurality of access technologies including 2^{nd} (2G), 2.5, 3^{rd} (3G), 4^{th} (4G), 5^{th} (5G) generation network technologies, including radio access for cellular systems, WLAN, Wireless Router (WR) mesh, and the like. Access technologies such as 2G, 3G, 4G, 5G, and future access networks may enable wide area coverage for mobile devices, such as one or more of client devices 200, with various degrees of mobility. For example, network 20 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Network 20 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, network 20 may include virtually any wired and/or wireless data communication mechanisms by which information may travel between one computing device and another computing device, network, and the like.

Referring still to FIG. 1 for an example embodiment, a user or client platform represented as client device 200 can correspond to any type of client computing or communication device enabling a user to submit transaction requests or access transaction data provided by the secure transaction network 10 via the network 20. Client devices 200 may include virtually any computing device that is configured to send and receive information over a network, such as network 20. Such client devices 200 may include mobile or portable devices, such as, cellular telephones, smart phones, camera phones, display pagers, radio frequency (RF) devices, infrared (IR) devices, global positioning devices (GPS), Personal Digital Assistants (PDAs), handheld computers, wearable computers, tablet computers, Internet of Things (IoT) devices, integrated devices combining one or more of the preceding devices, and the like. The client devices 200 may also include other computing devices, such as personal computers (PCs), multiprocessor systems, microprocessor-based or programmable consumer electronics, network PC's, and the like. The client devices 200 may also include other processing devices, such as consumer electronic (CE) devices and/or embedded computing devices, which are known to those of ordinary skill in the art. As such, the client devices 200 may range widely in terms of capabilities, features, and resources. For example, a client device 200 configured as a basic cellphone may have a low-capability data processor, a numeric keypad and a few lines of monochrome LCD display on which only text may be displayed. In another example, a more sophisticated web-enabled client device 200 may have a more robust data processor, a higher level of memory resources, a touch sensitive screen, a stylus, and a full screen color LCD display in which both text and graphics may be displayed. Moreover, the web-enabled client device 200 may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScriptTM, EXtensible HTML (xHTML), Compact HTML (CHTML), and the like, to display and/or send digital information. In other embodiments, mobile devices can be configured with applications (apps) with which the functionality described herein can be implemented.

The client device 200 may also include at least one client application that is configured to interact with the secure transaction network 10 via network 20. In an example embodiment, the client application can be a wallet 205 corresponding to a software module for execution by a data processor of the client device 200, the wallet 205 being configured to manage a user's digital cash and the secure transactions related thereto. In particular, the wallet 205 enables a user of a client device 200 to send and receive digital cash and related secure transactions via the secure transaction network 10.

Referring still to FIG. 1 for an example embodiment, the secure transaction network 10 can include a plurality of distributed computing nodes or network nodes 100 in networked data communication with each other and with client devices 200 via network 20. Each of the network nodes 100 can correspond to any type of secure computing device or secure computing environment enabling the secure processing of client transactions within the secure transaction network 10. In an example embodiment, network nodes 100 may include virtually any computing device that is configured to send and receive information over a network, such as network 20. Such network nodes 100 may include server computers, server farms, personal computers (PCs), PC arrays, multiprocessor systems, multi-computer systems, multiple core systems, microprocessor-based systems, single silicon wafer resident processors, multiple silicon wafer resident processors, quantum computing systems, and the like.

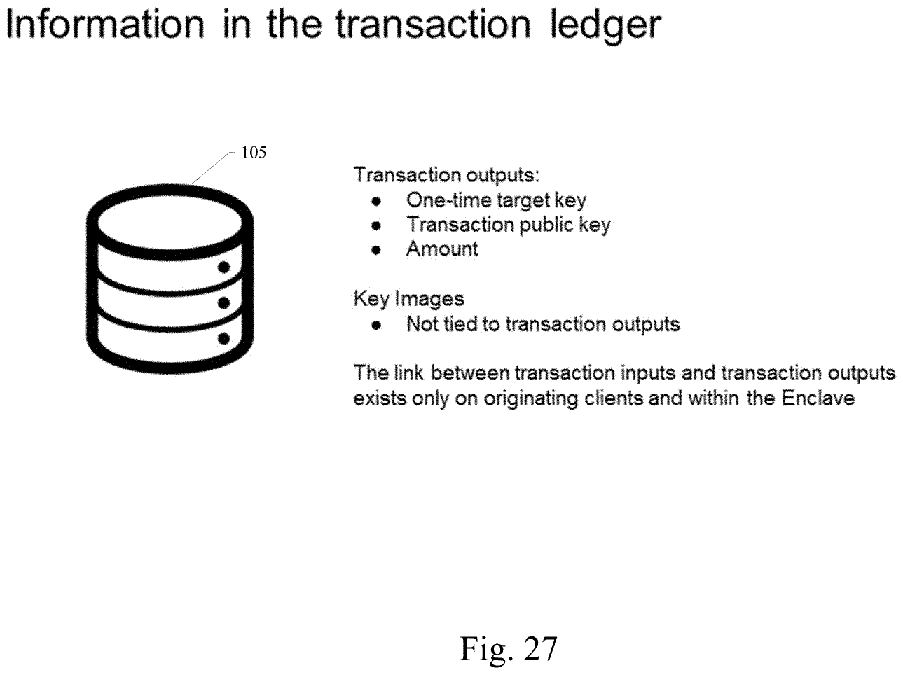

Each of the network nodes 100 of the secure transaction network 10 can include or be coupled with a transaction ledger 105 for storage of secure transaction data, key images, and related information. In an example embodiment, the transaction ledger 105 can be implemented as a secure data storage device, a database, a secure memory area or partition, or the like. Additional details of the information stored in the transaction ledger 105 are provided below and in connection with FIG. 27.

As shown in FIG. 1, the network nodes 100 of an example embodiment also include an internal secure computing environment or enclave 110. The enclave 110 represents a secure computing environment having: 1) an encrypted, isolated, and/or sequestered memory (e.g., random access memory or RAM); 2) isolated processing logic that cannot make or receive calls from an operating system (OS); and 3) an ability to attest to the authenticity and security of the secure computing environment upon request from a client device 200 or another network node 100. In a particular example embodiment, the enclave 110 can be implemented as an Intel® Corporation Software Guard Extensions (SGX) architecture. SGX is a set of central processing unit instruction code from Intel® that allows user-level code to allocate private regions of memory, called enclaves, which are protected from processes running at higher privilege levels. In the network nodes 100 with SGX enclaves 110 of the particular example embodiment, the network nodes 100 are configured to run with an SGX secure enclave 110. The SGX enclave 110 is isolated from the host OS in hardware-encrypted RAM, which prevents the network node 100 operator from having access into the enclave 110. SGX also supports a feature known as remote attestation, which allows a remote client or other external computing system to determine that a network node 100 is running a specific and authenticated software component inside an SGX enclave 110. The remote attestation can be performed over the network 20. By performing remote attestation of the enclaves 110 before establishing encrypted communication channels between network nodes 100, the entire transaction ledger 105 is configured to remain sealed within SGX enclaves 110 across the entire secure transaction network 10. As a result, the transaction ledger 105 can be distributed among all network nodes 100 of the secure transaction network 10; however, the contents of the transaction ledger 105 will never be accessible or viewable by humans, even the operators of the network nodes 100, as long as the SGX enclaves 110 and the secure transaction network 10 software remains secure. It will be apparent to those of ordinary skill in the art in view of the disclosure herein that secure enclaves 110 can be implemented with a secure computing environment other than Intel® SGX architecture.

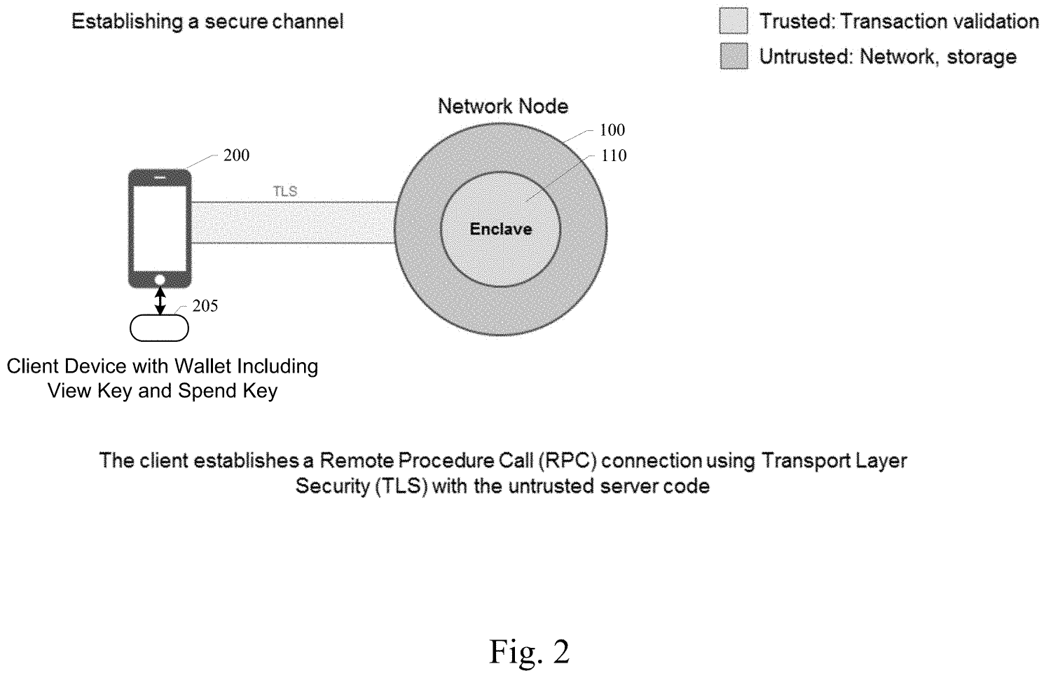

FIGS. 2 through 19 illustrate an example embodiment of a system and method for initiating and managing secure transactions between a user of a client device 200 and the secure transaction network 10. In an example embodiment from the user's perspective, when the user (sender) with a client device 200 wants to send a transaction (e.g., a digital cash payment) to a recipient, the sender merely needs the public address of the recipient's wallet 205. The sender can choose the amount of the digital cash payment and initiate the transaction with client device 200. In the manner described in more detail below, the secure transaction network 10 accepts the sender's transaction and securely transfers the requested amount of digital cash from the sender's wallet 205 to the recipient with the designated recipient wallet address.

In an example embodiment, wallets 205 hold two important elements of information: a public address and private keys. A public address is like a user's PO Box at the post office and a private key is like the key that opens the user's PO Box. The user can give out or make public their PO Box number (or public address) so other people can send mail (or initiate transactions) with the user. However, the user keeps their private keys private so other people cannot open the user's PO Box (or access the user's wallet 205) without authorization.

When using the secure transaction network 10 of an example embodiment, the user wallet 205 stores the user's private keys on the user's client device 200. However, the secure transaction network 10 never has access to a user's private key, so the secure transaction network 10 can never access the user's wallet 205 or create transactions without user authorization. The secure transaction network 10 does not control the wallet 205 software executing on the client device 200. When using the secure transaction network 10, the user can use their wallet 205 to choose where and how to store their keys. The secure transaction network 10 is configured to process anonymized transactions from the client device 200 without having access to the wallet 205 on the client device 200.

In general, wallets 205 on client devices 200 have three main functions: maintaining a public address, securing user private keys, and storing user transaction records. The public address is an anonymized address corresponding to a particular wallet 205, which a user can use to receive transactions (e.g., digital cash payments). In an example embodiment, the wallet 205 manages two separate private keys: a view private key (herein the view key), and a spend private key (herein the spend key). The view key enables the user to view the user's transactions. The spend key enables the user to initiate spending transactions. The use of these private keys is described in more detail below. The public address for a particular wallet 205 is derived from the view key and the spend key using elliptic curve cryptography.

When a sender user of a client device 200 wishes to initiate a transaction with a recipient user of another client device 200 using the secure transaction network 10, the sender user must obtain and provide the public address of the recipient user's wallet 205. In a particular embodiment, the public address of the recipient user's wallet 205 can be a one-time use, anonymized public address or key for the transaction being initiated. In the particular embodiment, transactions may consist of one-time keys and one-time ring signatures based on a set of well-known technologies called CryptoNote™. A one-time key is a way for the sender to create an address that only the recipient can find and spend. A one-time ring signature is a way of anonymizing the ownership of any of the amounts attached to a particular one-time key.

One-time public keys are composed of the recipient's public address or key and an arbitrary random number selected by a sender. By using cryptography, the sender can create a key, which both the sender and the recipient can look up, but only the recipient can send (all without revealing the random number selected by the sender).

One-time ring signatures are composed of a set of transactions that all could possibly be the right amount to sum to the total the sender wants to send to the recipient and the authorization to spend enough digital cash to complete the transaction in the form of a key image. Key images are one-time ring signatures that only the recipient of a transaction can create. Once the one-time key and one-time ring signatures are ready, the sender user's wallet 205 can connect to a network node 100 of the secure transaction network 10 to transmit the pending transaction.

User wallets 205 of client devices 200 connect to network nodes 100, which form the secure transaction network 10. In the secure transaction network 10, network nodes 100 are configured to perform the processing of transaction propagation including transaction ledger 105 management and consensus. Network nodes 100 receive transaction requests from user wallets 205, check and verify that the transaction requests are well-formed and valid, and then propose the validated transaction requests to the secure transaction network 10. If other network nodes 100 of the secure transaction network 10 agree that the transaction is valid and should be committed and recorded in the transaction ledger 105, the transaction is added to the transaction ledger 105 and the recipient can subsequently spend the digital cash transferred as part of the valid transaction.

The network nodes 100 of the secure transaction network 10 are configured to operate with as little knowledge as possible. All communication between wallets 205 of client devices 200 and network nodes 100 takes place over secure channels so the communication cannot be read by network node 100 operators or by persistent monitoring of the communication channels. The network nodes 100 of the secure transaction network 10 are also configured to use secure enclave technology, described above, to ensure that specific and validated software is running within the enclave 110 of a particular network node 100 at a given moment. Whenever a wallet 205 connects to a network node 100, the wallet 205 causes a remote attestation of the software running within the enclave 110 of the network node 100 with an independent party or attestation service. The remote attestation is a check to ensure that the software running within the enclave 110 of the network node 100 is validated. If a network node 100 fails this challenge, the wallet 205 will not send any transactions to the network node 100.

Once a network node 100 has been verified, a transaction with a wallet 205 of a client device 200 can begin. In a transaction, the wallet 205 creates a proposed entry for the transaction ledger 105. In an example embodiment, the proposed entry can consist of a one-time public key and a one-time ring signature or key image as described above. The wallet 205 can send the proposed entry corresponding to the transaction to a network node 100 over a secure communication channel via network 20. The network node 100 receives the transaction and performs a validation check of the transaction from inside of the network node's enclave 110. The validation check verifies two features: 1) if the one-time public key of the received transaction already exists in the transaction ledger 105, and 2) if the one-time key image of the received transaction already exists in the transaction ledger 105. If neither the one-time public key nor the one-time key image are in the transaction ledger 105, the network node 100 proposes the transaction to the secure transaction network 10 in a ballot or nomination. If other network nodes 100 of the secure transaction network 10 agree that the transaction is valid, the transaction output is committed and recorded in the transaction ledger 105 and the one-time key images become burned meaning that the key images can't be used again. All other information related to the transaction can be discarded. At this point, the recipient can look up which transaction outputs belong to them in the transaction ledger 105 and spend them by calculating the one-time private key that corresponds to the one-time public key the sender created for them. Note that in the example embodiment, there is no information that ties or connects a specific burned key image to a specific transaction output. However, if a burned key image is already present in the transaction ledger 105, the digital cash tied to that key cannot be spent again. This is how the transaction ledger 105 can prevent double spends without knowing which transaction is being attempted again.

User transactions (e.g., payments) with the secure transaction network 10 of an example embodiment are initiated by wallets 205 on a sender client device 200, validated and added to the transaction ledger 105 by the network nodes 100, and made available to spend by a recipient client device 200 with their wallet 205. The process in an example embodiment begins with a sender wallet 205 initiating a transaction by establishing a secure channel in the secure transaction network 10. FIGS. 2 through 6 illustrate an example embodiment of a system and method for establishing a secure channel in the secure transaction network 10.

Referring to FIG. 2, the sender wallet 205 of client device 200 can establish a remote procedure call (RPC) with a network node 100. The RPC can establish a connection with the network node 100 using Transport Layer Security (TLS). The TLS protocol is a well-known protocol that aims primarily to provide privacy and data integrity between two or more communicating computer applications. Initially, the sender wallet 205 communicates with untrusted server code in the network node 100. As described above, a public address or key of the recipient wallet 205, a private view key of the sender, and a private spend key of the sender are maintained in the sender wallet 205.

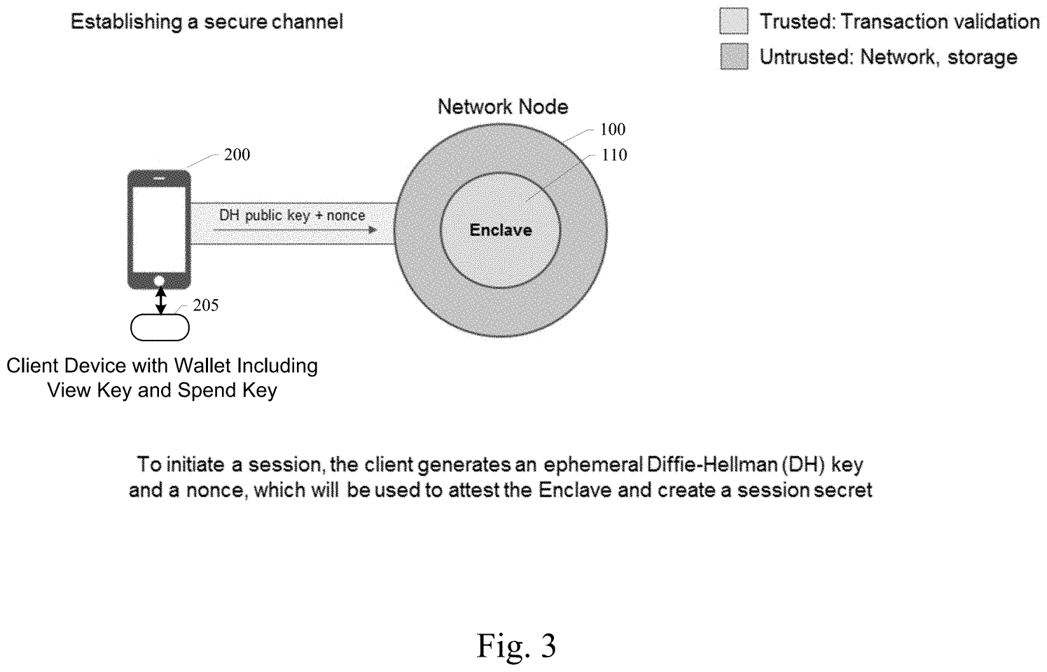

Referring to FIG. 3, the sender wallet 205 of client device 200 can initiate a private session by generating an ephemeral Diffie-Hellman (DH) key and a nonce. The use of DH keys is a well-known process used to establish a shared secret between two parties. In cryptography, a nonce is an arbitrary number that can be used just once in a cryptographic communication. A nonce is often a random or pseudo-random number generated for a private communication to ensure that old communications cannot be reused in replay attacks. The combination of the DH key and the nonce creates a one-time use key used by the sender wallet 205 to attest the authenticity of the enclave 110 of the network node 100 and to create a session secret for the secure communication between the wallet 205 and the enclave 110 of the network node 100. The one-time use key is sent by the wallet 205 to the untrusted code of the network node 100.

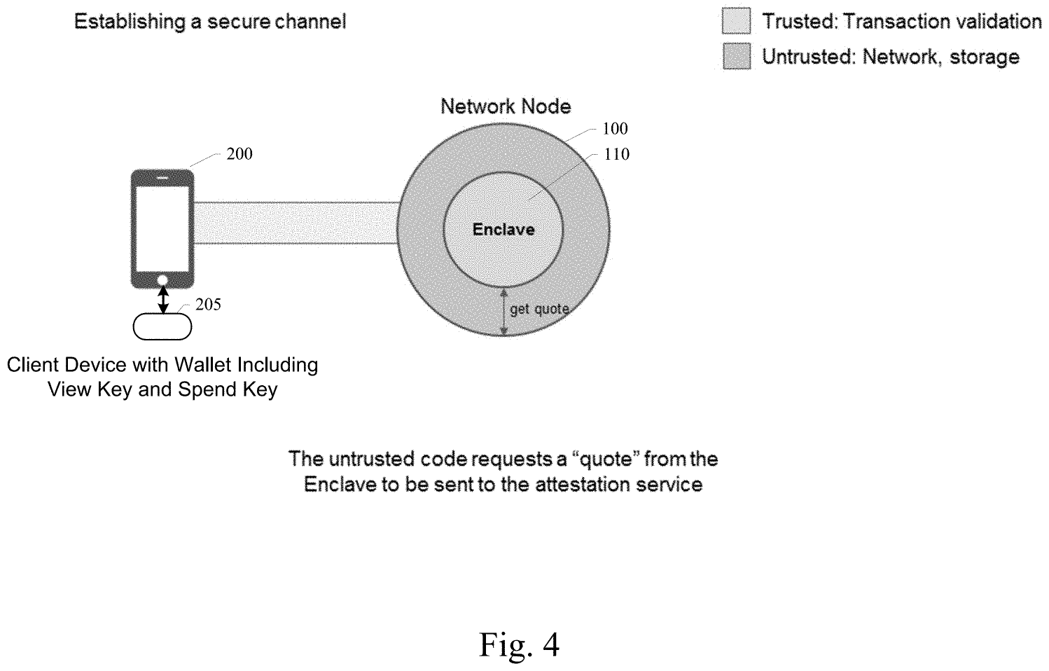

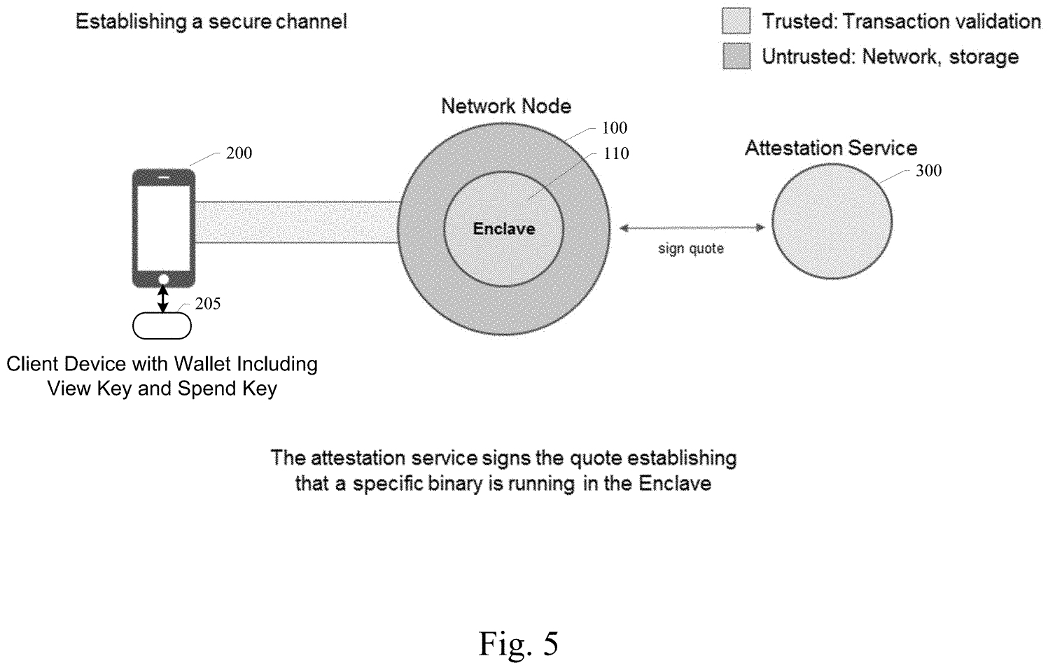

Referring to FIG. 4, the untrusted code of the network node 100 receives the one-time use key sent by the wallet 205. The receipt of the one-time use key causes the untrusted code of the network node 100 to generate a quote request, which is sent to the enclave 110 of the network node 100 from the untrusted code. The quote request causes the enclave 110 to perform a remote attestation with an independent party or attestation service as shown in FIG. 5.

Referring to FIG. 5, the enclave 110 uses the quote from the quote request in a secure communication with an attestation service 300 to perform a remote attestation of the enclave 110 with an independent party. The remote attestation is a check to ensure that the software running within the enclave 110 of the network node 100 is a specific and validated executable component. If the attestation service 300 can validate the enclave 110 executable component, the attestation service 300 signs the quote and sends the signed quote back to the enclave 110. If the network node 100 fails this remote attestation challenge, the session fails and the sender wallet 205 is notified to not send any transactions to the network node 100.

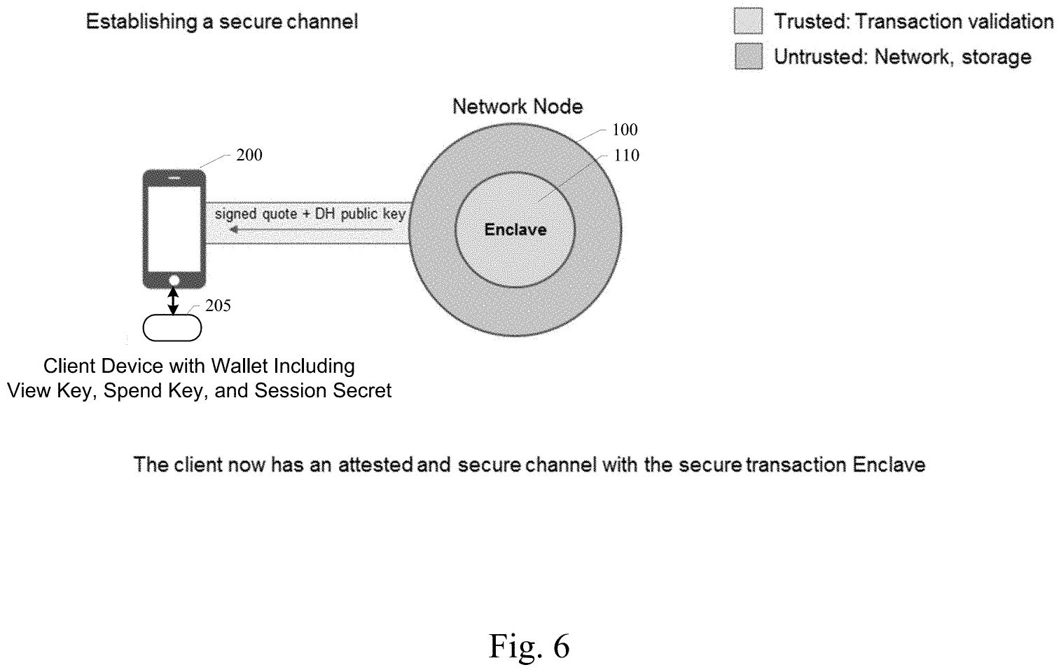

Referring to FIG. 6, assuming the attestation service 300 can validate the enclave 110 executable component, the enclave 110 receives the signed quote from the attestation service 300. The signed quote along with the DH key can be used by the network node 100 to generate a session secret/key to enable the secure channel with the sender wallet 205. The session secret can be sent from the network node 100 to the sender wallet 205. The session secret assures the wallet 205 that the wallet 205 is communicating on a secure communication channel with a validated enclave 110 of the network node 100. This session secret, and the secure channel enabled thereby, can be used by the wallet 205 for subsequent communications with the network node 100.

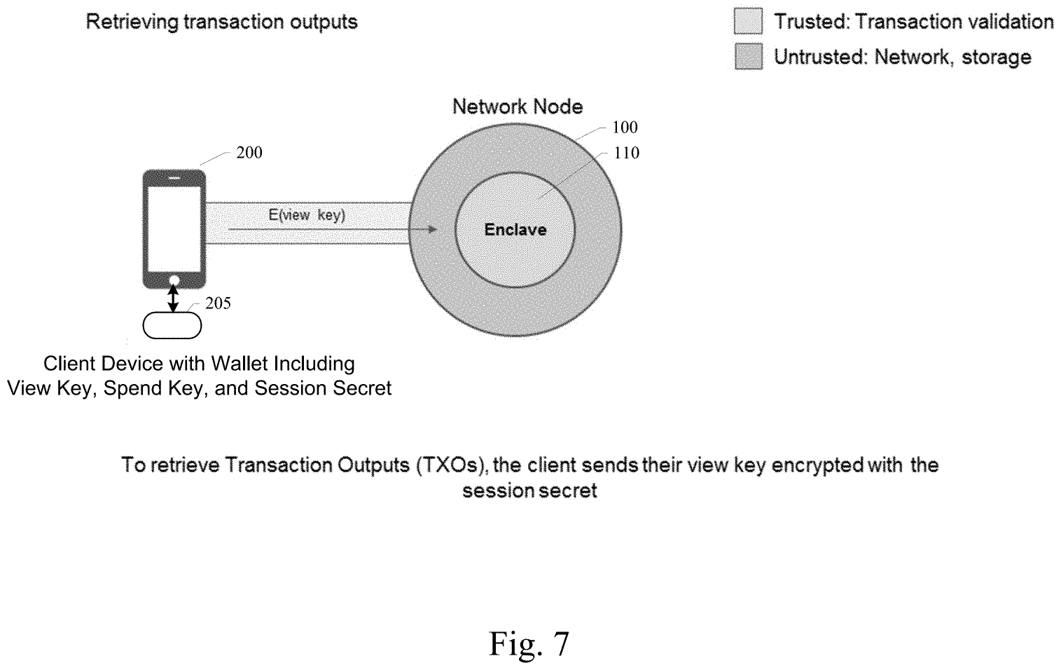

Once the wallet 205 has established a secure channel with a network node 100 as described above, the wallet 205 can begin to make transaction requests and retrieve transaction output from the network node 100. FIGS. 7 through 9 illustrate an example embodiment of a system and method for retrieving transaction outputs in the secure transaction network 10.

Referring to FIG. 7, the wallet 205 can generate a transaction request to the network node 100 by encrypting the view key with the session secret. This encrypted view key is sent to the network node 100 via the secure communication channel. The encrypted view key enables the wallet 205 to retrieve transaction outputs (TXOs) from the network node 100.

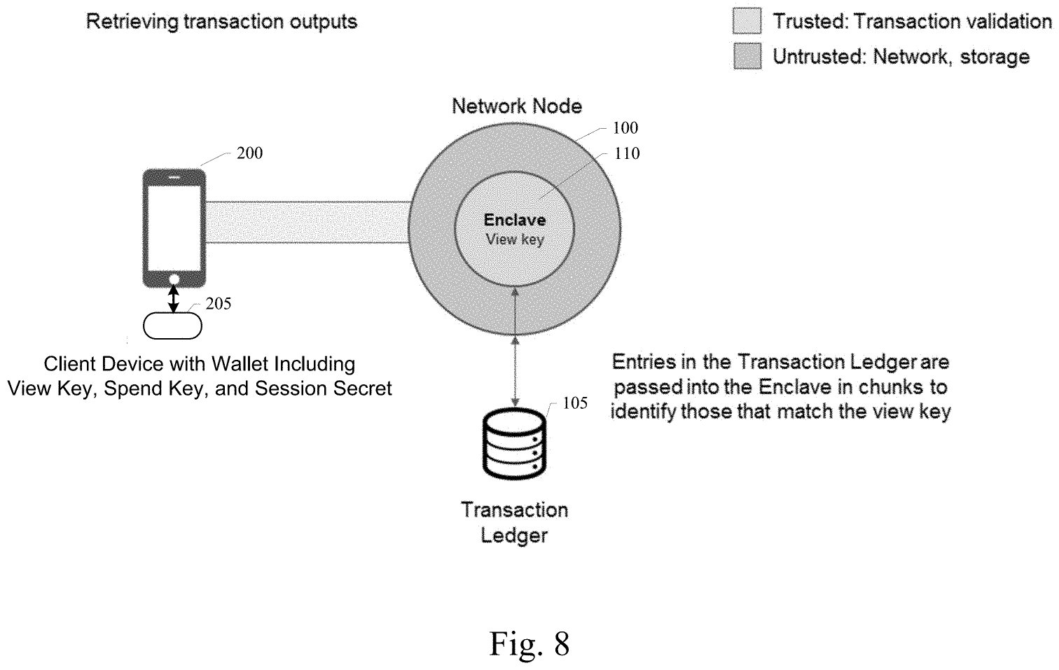

Referring to FIG. 8, the verified enclave 110 of the network node 100 receives the encrypted view key from the wallet 205. Given the shared session secret, the enclave 110 can decrypt the view key. In a secure communication with transaction ledger 105, the enclave 110 can use the view key to identify entries in the transaction ledger 105 that match the view key. The matching entries can be passed from the transaction ledger 105 to the enclave 110. Alternatively, groups or chunks of transaction ledger 105 entries can be passed into the enclave 110 to identify those that match the view key.

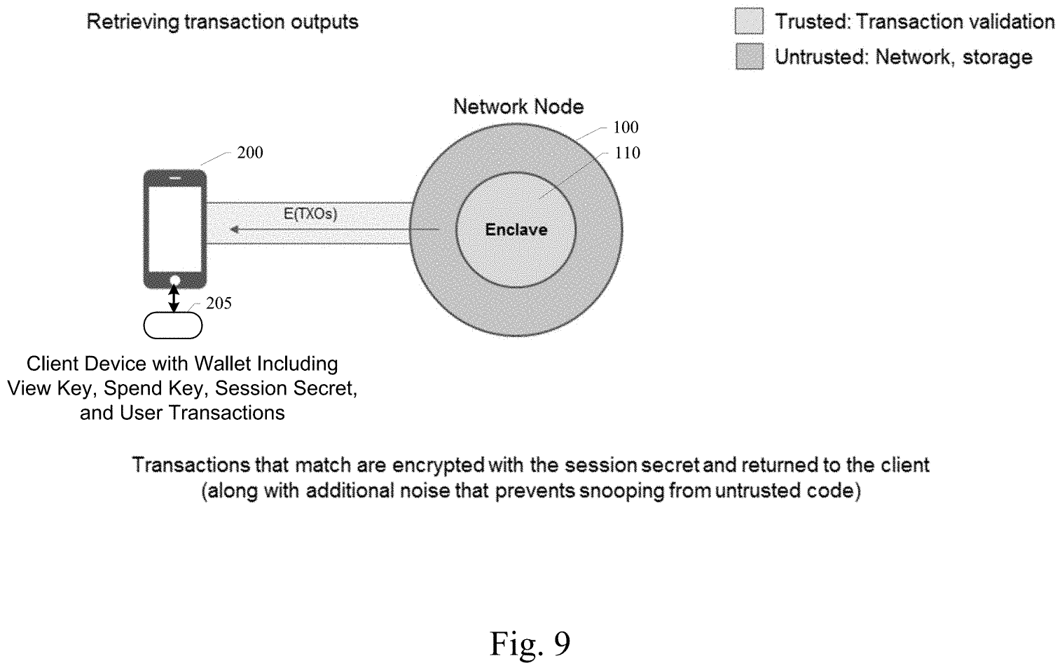

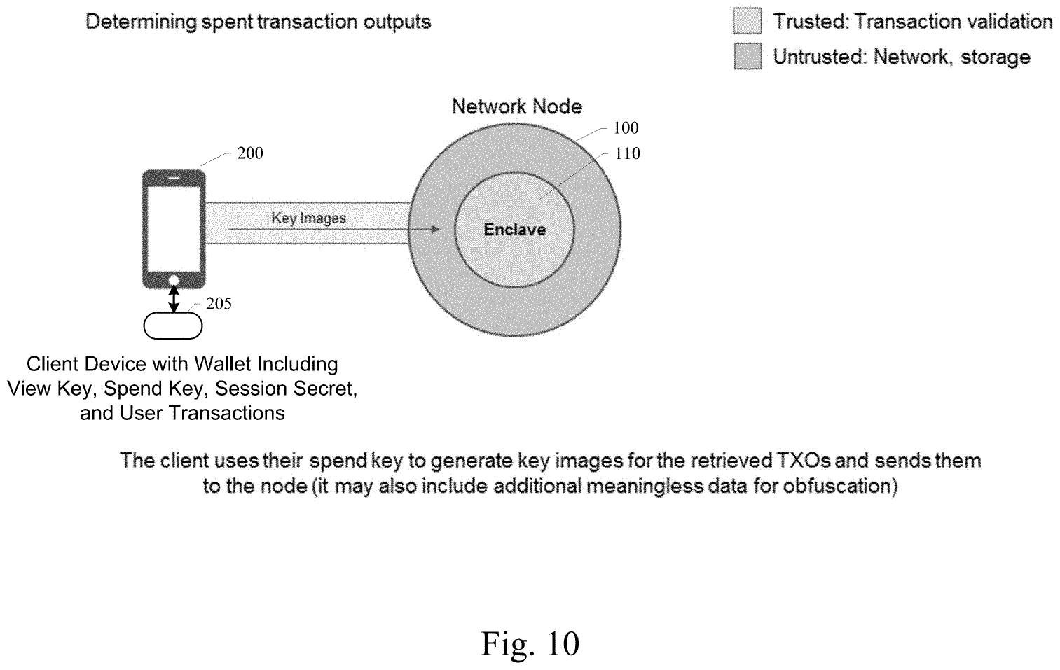

Referring to FIG. 9, entries in the transaction ledger 105 that match the view key can be encrypted by the enclave 110 with the session secret. The matching encrypted transactions (TXOs) can be sent to the wallet 205 via the secure communication channel. Noise data (meaningless data) can be added to the transfer of the TXOs to obfuscate the transmission and prevent snooping from untrusted code. The wallet 205 can use the session secret to decrypt the retrieved TXOs. At this point, the user transactions corresponding to the user's view key can be managed in the user's wallet 205. As part of this transaction management, the wallet 205 may want to identify or determine spent transaction outputs to calculate the user's available balance of spendable digital cash. This process is described in detail in connection with FIGS. 10 through 12.

FIGS. 10 through 12 illustrate an example embodiment of a system and method for determining spent transaction outputs in the secure transaction network 10. Referring to FIG. 10, the user of client device 200 has retrieved the user transactions (TXOs) corresponding to the user's view key as described above. As shown in FIG. 10, the user can use their spend key to generate key images corresponding to the retrieved TXOs. Key images are one-time ring signatures that only the recipient of a transaction can create. One-time ring signatures are composed of a set of transactions that all could possibly be the right amount to sum to the total the sender wants to send to the recipient and the authorization to spend enough digital cash to complete the transaction. The user's wallet 205 can use the spend key to generate key images corresponding to the retrieved TXOs and transfer the key images to the network node 100 and the enclave 110 via the secure communication channel. The transfer of the key images can be combined with noise data for obfuscation.

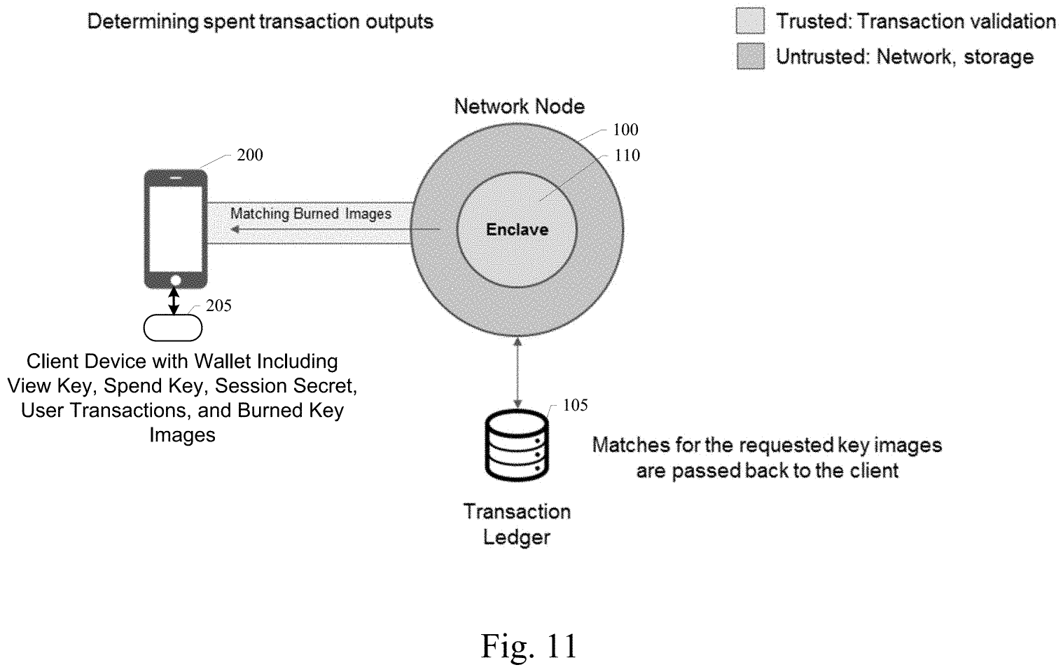

Referring to FIG. 11, in a secure communication with transaction ledger 105, the enclave 110 can use the key images to identify entries in the transaction ledger 105 that match the requested key images. The matching entries can be passed from the transaction ledger 105 to the enclave 110 and from the enclave 110 to the requesting wallet 205. The entries from the transaction ledger 105 that match the requested key images represent burned one-time key images that can't be used again.

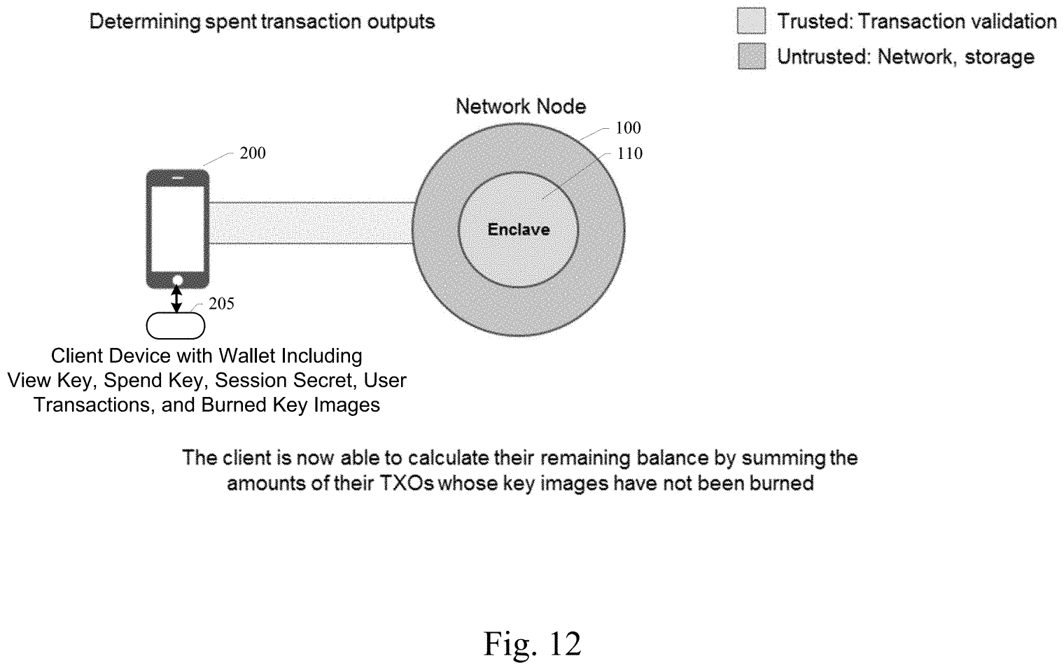

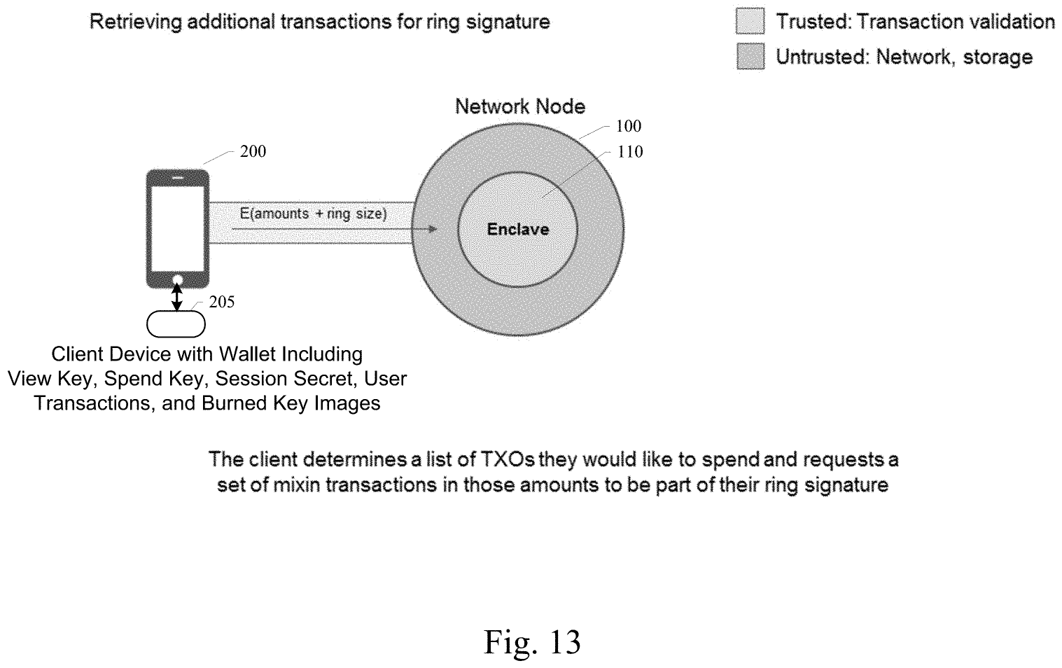

Referring to FIG. 12, the wallet 205 can use the matching burned key images received from the enclave 110 to calculate the user's available balance of spendable digital cash. This available or remaining balance is calculated by summing the amounts of the user's transactions that have not been burned. The user's available balance of spendable digital cash can be used to transfer a payment from the sending user to a receiving user via the secure transaction network 10. Such a payment can be made by generating a list of transactions that the sending user would like to spend, wherein the amounts of the transactions on the list sum to the desired payment. The listed transactions to be spent and a set of additional transactions for ring signature can be retrieved from the secure transaction network 10 using the process detailed below in connection with FIGS. 13 through 15.

FIGS. 13 through 15 illustrate an example embodiment of a system and method for retrieving additional transactions for ring signature in the secure transaction network 10. Referring to FIG. 13, the sending user wallet 205 can generate a list of transactions that the sending user would like to spend, based on the sending user's available balance. This list of transactions needs to be combined with additional (mixin) transactions to render an effective and secure ring signature. The quantity of additional mixin transactions and the size of the ring for ring signature can also be defined by the wallet 205 as a ring size. The wallet 205 can encrypt the list of transactions with corresponding amounts along with the ring size and send the encrypted data to the enclave 110 as a request for the additional mixin transactions on the secure communication channel.

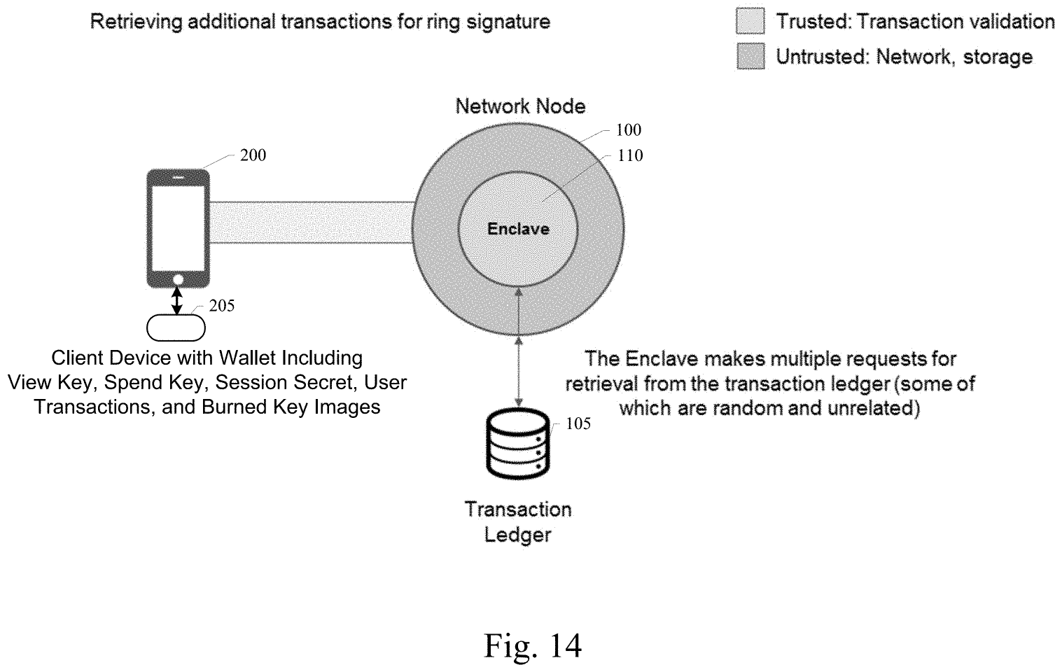

Referring to FIG. 14, in a secure communication with transaction ledger 105, the enclave 110 can use the request for the additional mixin transactions to make multiple requests for the retrieval of entries from the transaction ledger 105 corresponding to the additional mixin transactions. Additional unrelated entries can also be retrieved from the transaction ledger 105 to obfuscate the collection of entries.

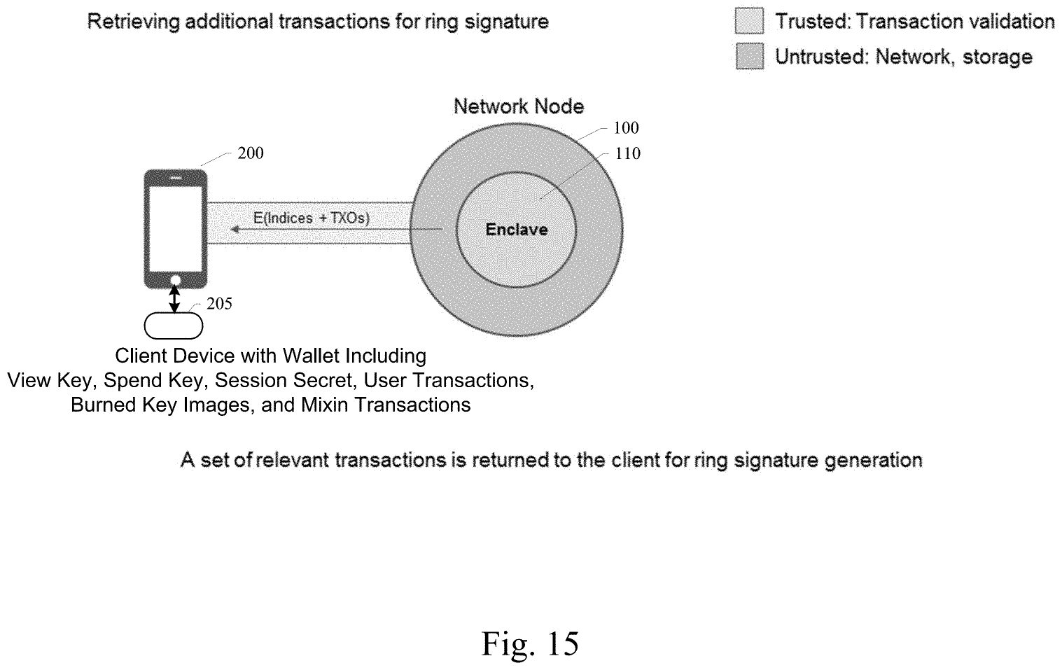

Referring to FIGS. 14 and 15, the retrieved additional mixin transactions and unrelated transactions can be passed from the transaction ledger 105 to the enclave 110, encrypted by the enclave 110, and passed from the enclave 110 to the requesting wallet 205. As a result, the wallet 205 has retrieved a set of relevant transactions, which the wallet 205 can use for ring signature generation.

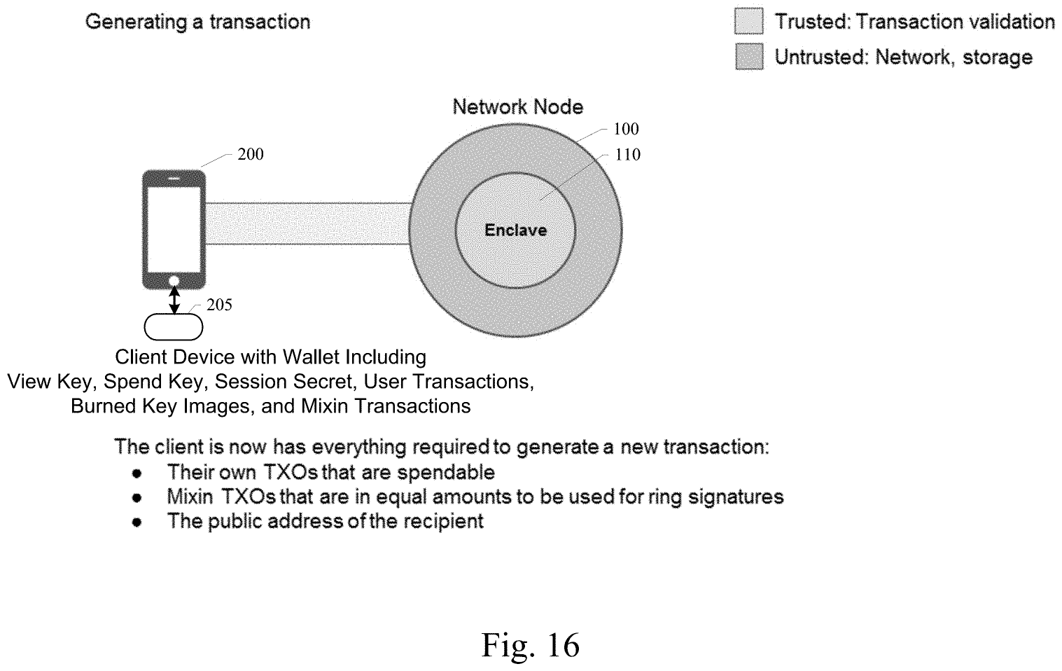

FIGS. 16 through 19 illustrate an example embodiment of a system and method for generating a transaction in the secure transaction network 10. Given the processing described above for the example embodiment, the wallet 205 has everything required to generate a new transaction. In particular as shown in FIG. 16, the wallet 205 has obtained or generated the following elements: 1) a set of spendable transactions as determined from the transaction ledger 105 via the enclave 110; 2) a set of additional mixin transactions in amounts equal to the spendable transactions, the additional mixin transactions having been retrieved from the transaction ledger 105 via the enclave 110; and 3) the public address of the recipient wallet 205 to which the sender user desires to send a payment of digital cash.

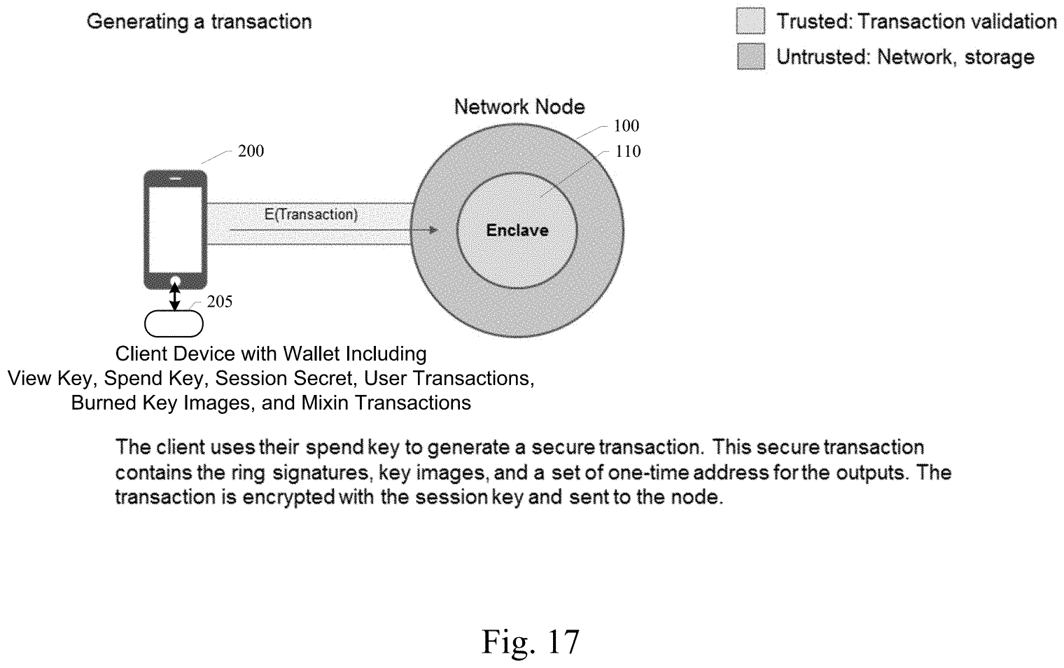

Referring to FIG. 17, the sender wallet 205 can use their spend key to generate a secure transaction. The secure transaction can include the ring signatures and key images corresponding to the spendable transactions and additional mixin transactions, and a set of one-time addresses for the transaction outputs. The secure transaction is encrypted by the sender wallet 205 with the session key/secret and sent to the enclave 110 of node 100 via the secure communication channel.

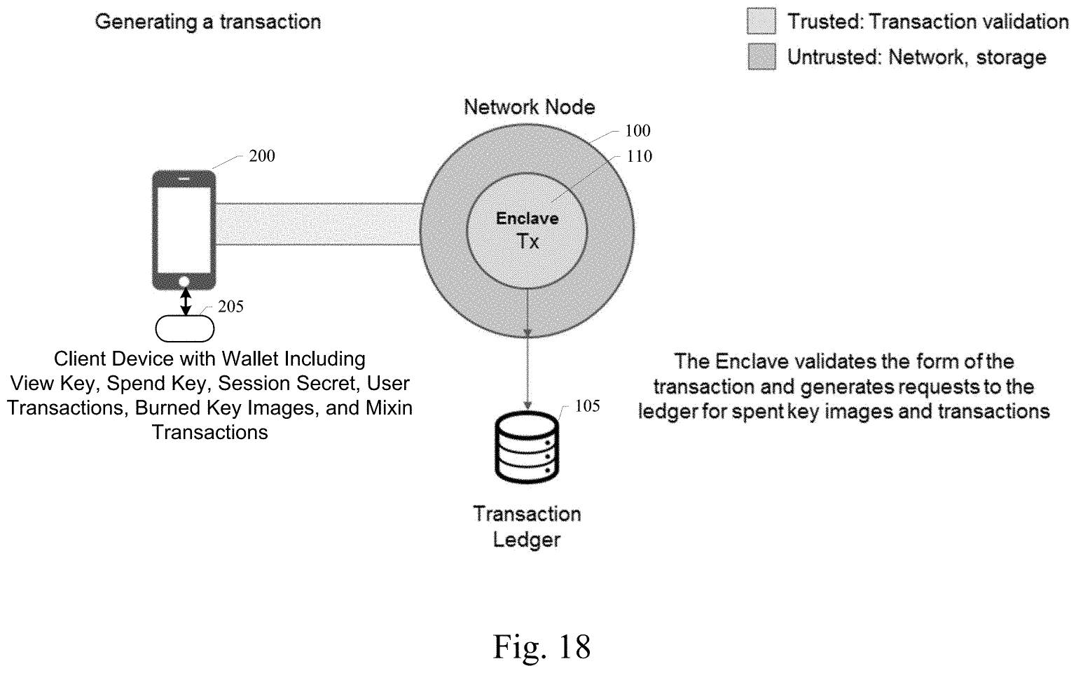

Referring to FIG. 18, the enclave 110 receives the encrypted secure transaction from the wallet 205. The enclave 110 can decrypt the received secure transaction using the session key/secret and validate the form of the secure transaction. In a secure communication with transaction ledger 105, the enclave 110 can generate requests for spent key images and transactions corresponding to the received secure transaction.

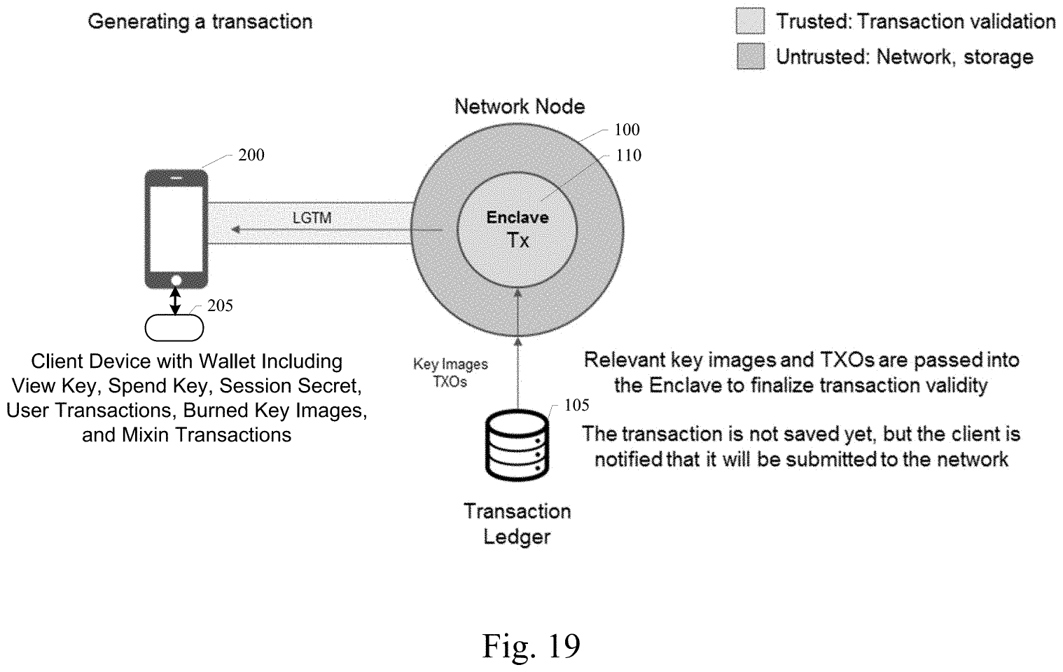

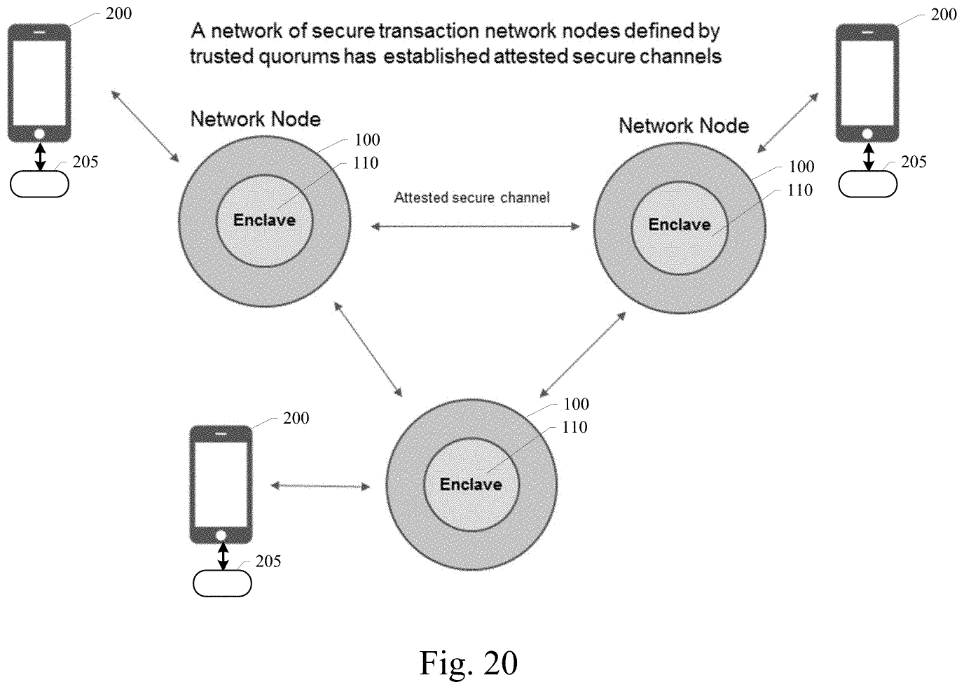

Referring to FIG. 19, the enclave 110 can receive relevant key images and transactions corresponding to the received secure transaction from the transaction ledger 105. The enclave 110 can process the relevant key images and transactions to finalize the validity of the secure transaction. Having validated the secure transaction, the enclave 110 notifies the wallet 205 that the secure transaction is validated by the particular network node 100, is pending approval by the secure transaction network 10, and will be submitted for validation to the secure transaction network 10. The process, in an example embodiment, for submitting secure transactions to the secure transaction network 10 and for obtaining validation of transactions and committing validated transactions to the transaction ledger 105 is detailed below in connection with FIGS. 20 through 25.

FIGS. 20 through 25 illustrate an example embodiment of the interaction between network nodes for processing secure transactions in the secure transaction network 10. Referring to FIG. 20, the secure transaction network 10 of an example embodiment is comprised of a plurality of network nodes 100, each having a validated and authenticated enclave 110 therein. As described above, each enclave 110 can be validated and authenticated with an independent party or attestation service 300 via a remote attestation process. Having validated the enclave 110 of each network node 100, attested secure communication channels can be established between the enclaves 110 of each network node 100. In this manner, the security of inter-node communications in the secure transaction network 10 can be assured. Similarly, as described above, the security of communications between network nodes 100 and the client devices 200 can also be assured. As a result, the secure transaction network 10 represents a trusted quorum of secure nodes in attested and secure data communication on secure communication channels.

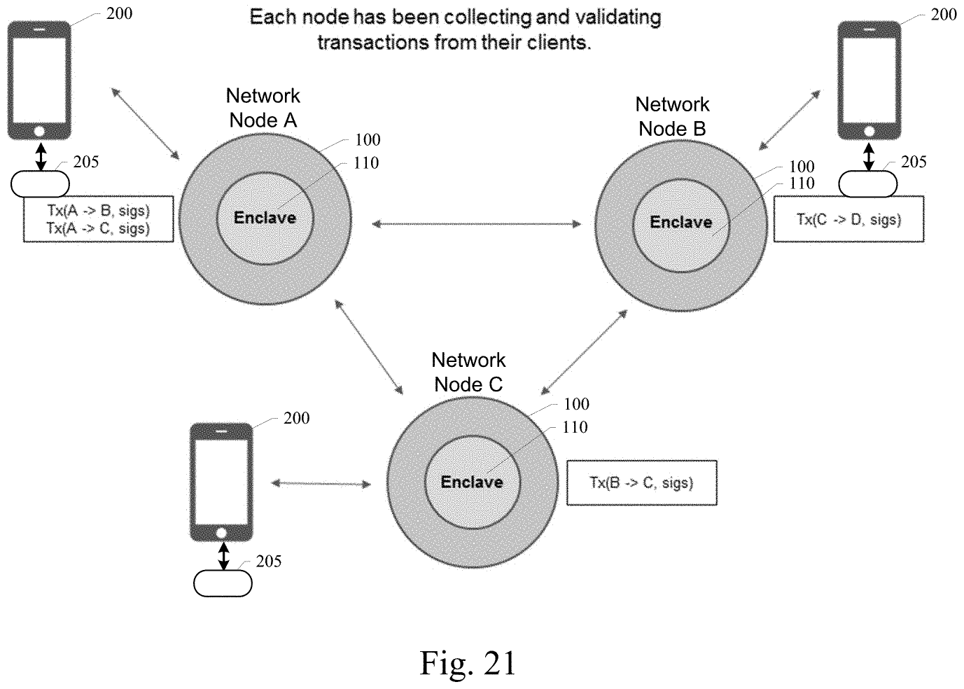

Referring to FIG. 21, as described above, each network node 100 can receive and validate secure transactions from the client devices 200 to which they are connected. Similarly, each network node 100 can submit validated secure transactions to the secure transaction network 10 for obtaining validation of transactions and for committing validated transactions to the transaction ledger 105. In the example shown in FIG. 21, Network Node A has collected two transactions: Tx(A→B, sigs), which corresponds to a transaction to transfer value from user A to user B, the transaction having the appropriate signatures; and Tx(A→C, sigs), which corresponds to a transaction to transfer value from user A to user C, the transaction also having the appropriate signatures. Network Node A wishes to submit these transactions to the secure transaction network 10 for validation and committal. Similarly, Network Node B has collected one transaction: Tx(C→D, sigs), which corresponds to a transaction to transfer value from user C to user D, the transaction having the appropriate signatures. Finally, in the example of FIG. 21, Network Node C has collected one transaction: Tx(B→C, sigs), which corresponds to a transaction to transfer value from user B to user C, the transaction having the appropriate signatures. Network Nodes B and C also wish to submit their transactions to the secure transaction network 10 for validation and committal.

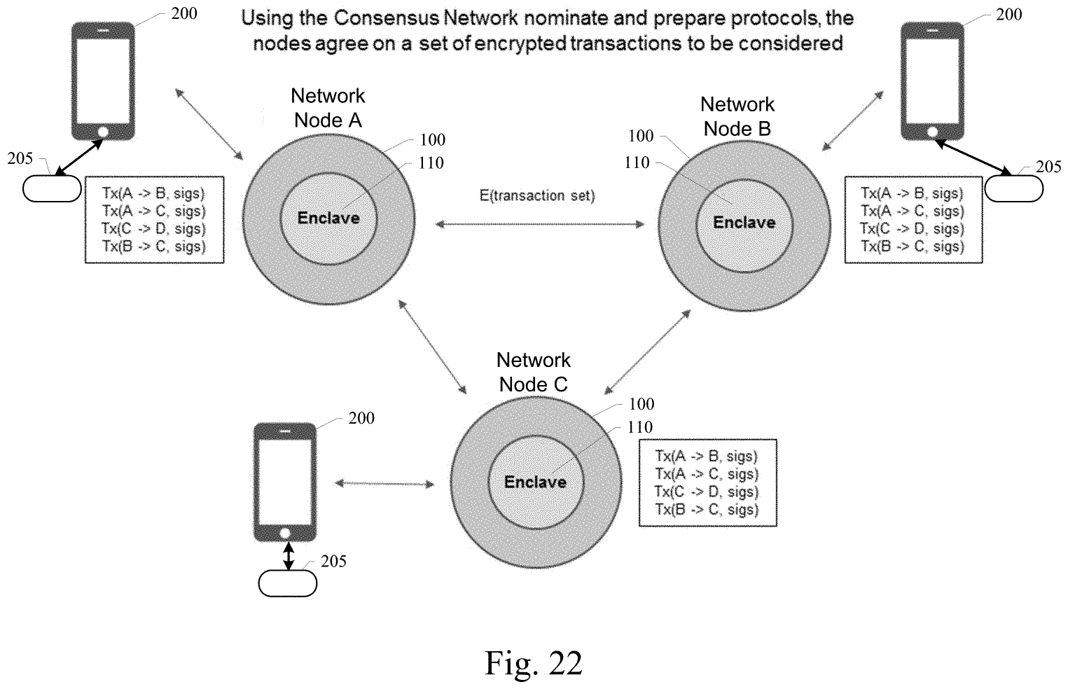

Referring to FIG. 22, Network Nodes A, B, and C can submit their transactions to the secure transaction network 10 for validation and committal. Each network node 100 can use a consensus network protocol to nominate their respective transactions to the secure transaction network 10. In a particular embodiment, the consensus network protocol can be implemented with the well-known Stellar Consensus™ Protocol (SCP), which provides a way for a set of network nodes to reach consensus on a set of transactions without relying on a closed system to accurately record transactions, including financial transactions. It will be apparent to those of ordinary skill in the art in view of the disclosure herein that other alternative consensus network protocols may also be used. As shown in the example of FIG. 22, each network node 100 can compile a complete set of the transactions nominated by each of the network nodes 100 of the secure transaction network 10. The nominated transactions can be encrypted for transfer between network nodes 100. Using the consensus network protocol, the network nodes 100 of the secure transaction network 10 can reach consensus and agree on a set of nominated transactions for consideration for validation and committal.

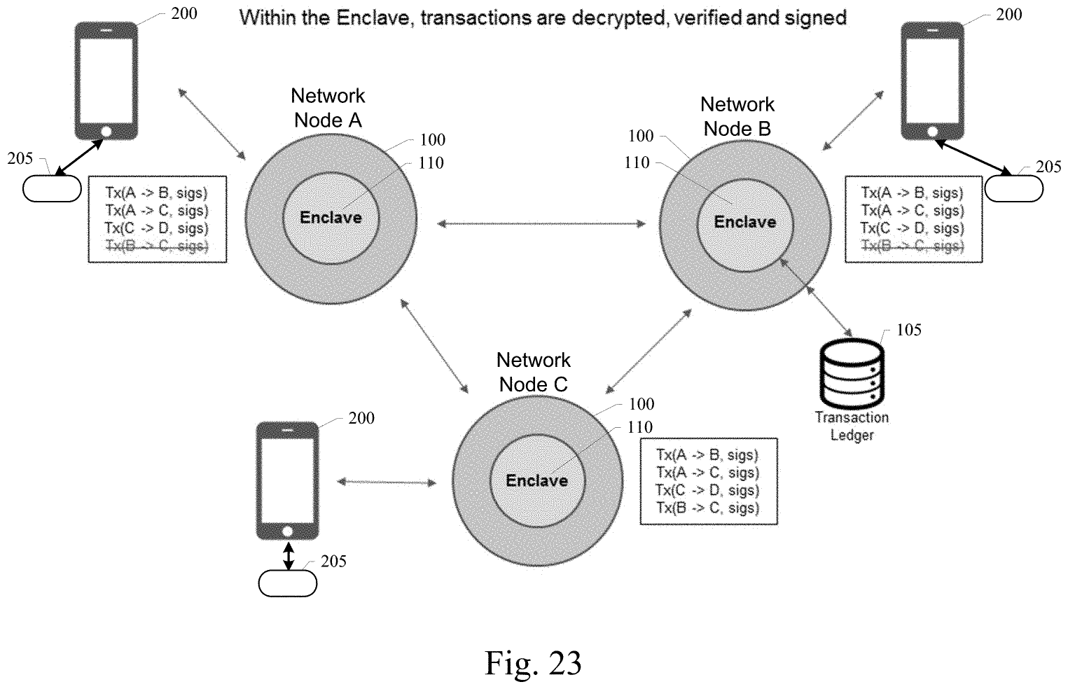

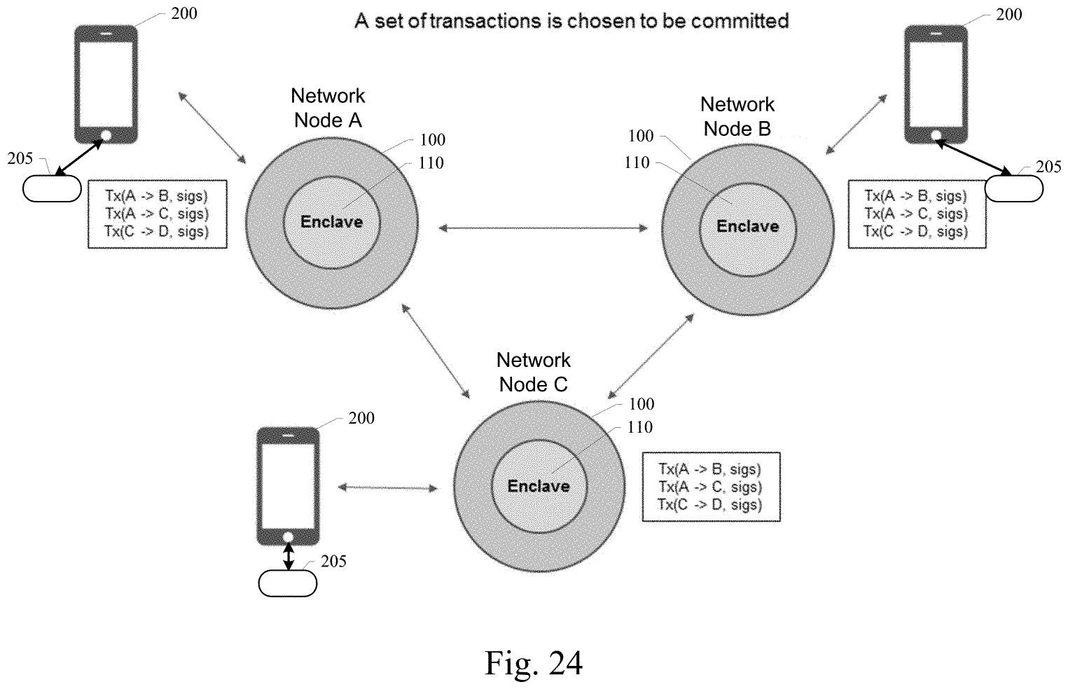

Referring to FIG. 23, each of the network nodes 100 of the secure transaction network 10 can use their secure enclave 110 to decrypt, verify, and sign each transaction of the agreed upon set of nominated transactions. In some cases, one or more network nodes 100 may reject, defer, or otherwise non-verify a nominated transaction because of pre-defined rules or protocols. Ultimately, a set of nominated transactions can be generated that have been verified and signed by all (or a pre-defined number) of the network nodes 100 of the secure transaction network 10. Rejected, deferred, or otherwise non-verified transactions can be removed from the set. An example of this set of verified and signed transactions is shown in FIG. 24. This set of verified and signed transactions, having been approved by the consensus of the secure transaction network 10, can be committed for storage in the transaction ledger 105.

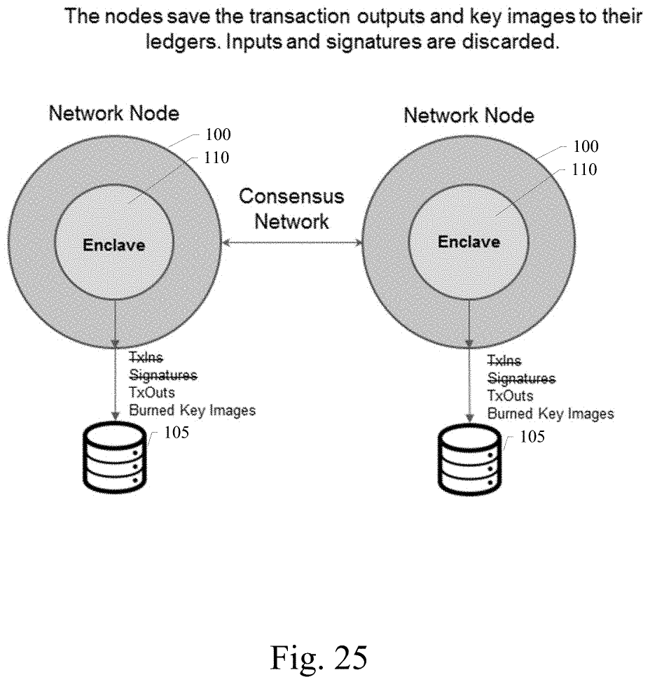

Referring to FIG. 25, each of the network nodes 100 of the secure transaction network 10 can save the transaction outputs and key images corresponding to the set of verified and signed transactions to their transaction ledgers 105. The transaction inputs and signatures can be discarded. The burned key images can also be retained to prevent double spending.

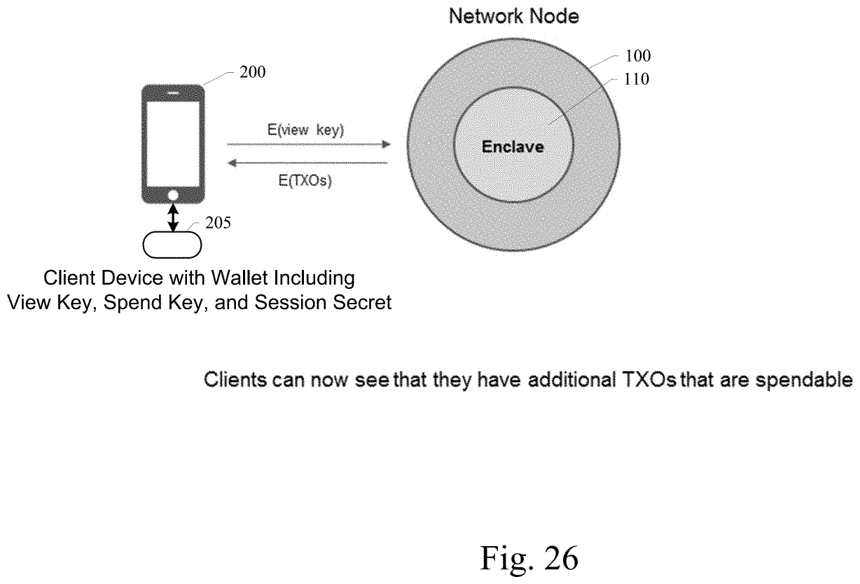

FIG. 26 illustrates an example embodiment of a system and method for enabling a client device to view spendable transactions in the secure transaction network 10. Once the set of verified and signed transactions have been committed for storage in the transaction ledger 105, a user of a client device 200 can use their view key to view their transactions as described above. If a particular user (recipient) has received a payment from another user as a new transaction in the transaction ledger 105, the new transaction will be made available to the recipient user in response to the view key request. In this case, the recipient user will have one or more additional transactions that are spendable because of the payment sent by another user via the secure transaction network 10. Thus, the secure transaction network 10 of the example embodiments as described herein enables users to use client devices 200 to view and initiate transactions to transfer value as digital cash between users. All necessary transaction detail and history is stored in the transaction ledger 105, as described below.

FIG. 27 illustrates an example embodiment of the information maintained in the transaction ledger 105 in the secure transaction network 10. As described above, a copy of the transaction ledger 105 is maintained by each of the network nodes 100 of the secure transaction network 10. The information stored in the transaction ledger 105 of an example embodiment can include: 1) transaction outputs, and 2) key images. Transaction inputs and signatures are not stored to increase the security and efficiency of the secure transaction network 10. For the transaction outputs, the transaction ledger 105 can also store one-time target keys, transaction public keys, and the amount or value associated with the transaction. Note that the key images are stored in a manner that does not tie or connect the key images to the corresponding transaction outputs. Moreover, the link between transaction inputs and transaction outputs exists only on the originating client devices 200 and within the enclave 110 of the network nodes 100. Again, these features improve the security and efficiency of the secure transaction network 10.

In the secure transaction network 10 of an example embodiment, transaction processing can be completed rapidly (e.g., in seconds or portions thereof). All transaction and balance information is kept private within the secure enclaves 110 of the network nodes 100 such that the transactions themselves are never visible to the operators of the network nodes 100. Transaction privacy is further protected with one-time public keys and one-time ring signatures. Even if an attacker is able to forge or copy an enclave signature in order to connect to the secure transaction network 10 with modified software/malware, the network node 100 operator and any attackers who may compromise a network node 100 will never have access to a user's private keys or any private user data; because, all user private keys and private user data are resident in the user's wallet 205 and never touches the secure transaction network 10. As a result, the secure transaction network 10 of the various example embodiments described herein is secure, efficient, rapid, and supports user-friendly secure transactions, especially on mobile applications and mobile devices.

The secure transaction network 10 of the various example embodiments described herein can be used in a wide variety of applications and vertical markets. For example, specific embodiments can be applied to online payment processing systems, financial asset management systems, crypto-currency systems, secure online digital content delivery systems, digital rights management systems, digital asset management systems, smart contract (e.g., ERC-20) systems, voting systems, merchant payment systems, or the like. It will be apparent to those of ordinary skill in the art in view of the disclosure herein that other applications of the technology and innovations disclosed herein are possible.

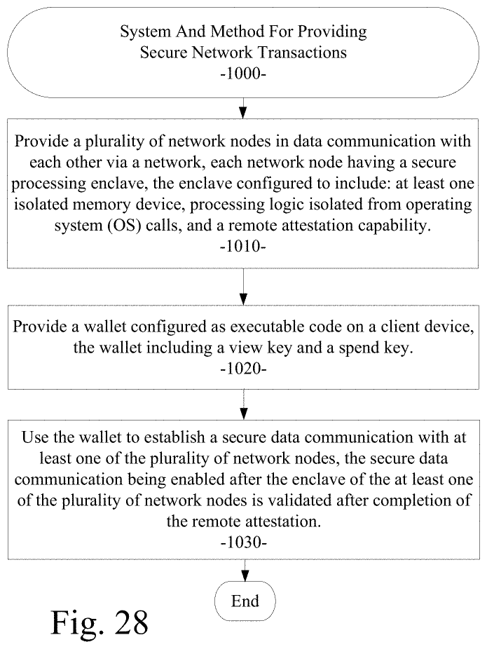

FIG. 28 is a processing flow diagram illustrating an example embodiment of the system and method for providing a secure transaction network as described herein. The method 1000 of an example embodiment includes: providing a plurality of network nodes in data communication with each other via a network, each network node having a secure processing enclave, the enclave configured to include: at least one isolated memory device, processing logic isolated from operating system (OS) calls, and a remote attestation capability (processing block 1010); providing a wallet configured as executable code on a client device, the wallet including a view key and a spend key (processing block 1020); and using the wallet to establish a secure data communication with at least one of the plurality of network nodes, the secure data communication being enabled after the enclave of the at least one of the plurality of network nodes is validated after completion of the remote attestation (processing block 1030).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A secure transaction network comprising:
a plurality of network nodes in data communication with each other via a network, each network node having a secure processing enclave, the enclave configured to include: at least one isolated memory device, processing logic isolated from operating system (OS) calls, and a remote attestation capability; and
a wallet configured as executable code on a client device, the wallet including a view key and a spend key, the wallet configured to establish a secure data communication with at least one of the plurality of network nodes, the secure data communication being enabled after the enclave of the at least one of the plurality of network nodes is validated after completion of the remote attestation.

2. The secure transaction network of claim 1 wherein the client device is a mobile device.

3. The secure transaction network of claim 1 wherein the enclave is implemented as a Software Guard Extensions (SGX) architecture.

4. The secure transaction network of claim 1 wherein each network node of the plurality of network nodes being in data communication with a transaction ledger.

5. The secure transaction network of claim 1 wherein the secure data communication being enabled after the wallet receives a signed quote and key.

6. The secure transaction network of claim 1 wherein the view key enabling the wallet to receive transaction outputs via the enclave.

7. The secure transaction network of claim 1 wherein the spend key enabling the wallet to initiate spending transactions via the enclave.

8. The secure transaction network of claim 1 wherein the wallet is configured to initiate transactions having one-time keys and one-time ring signatures.

9. The secure transaction network of claim 1 wherein the wallet is configured to initiate transactions causing digital cash to be transferred from a first client device to a second different client device.

10. A method comprising:
providing a plurality of network nodes in data communication with each other via a network, each network node having a secure processing enclave, the enclave configured to include:
at least one isolated memory device, processing logic isolated from operating system (OS) calls, and a remote attestation capability;
providing a wallet configured as executable code on a client device, the wallet including a view key and a spend key; and
using the wallet to establish a secure data communication with at least one of the plurality of network nodes, the secure data communication being enabled after the enclave of the at least one of the plurality of network nodes is validated after completion of the remote attestation.

11. The method of claim 10 wherein the client device is a mobile device.

12. The method of claim 10 wherein the enclave is implemented as a Software Guard Extensions (SGX) architecture.

13. The method of claim 10 wherein each network node of the plurality of network nodes is in data communication with a transaction ledger.

14. The method of claim 10 wherein the secure data communication is established after the wallet receives a signed quote and key.

15. The method of claim 10 including using the view key to enable the wallet to receive transaction outputs via the enclave.

16. The method of claim 10 including using the spend key to enable the wallet to initiate spending transactions via the enclave.

17. The method of claim 10 including using the wallet to initiate transactions having one-time keys and one-time ring signatures.

18. The method of claim 10 including using the wallet to initiate transactions causing digital cash to be transferred from a first client device to a second different client device.

19. In a secure transaction network having a plurality of network nodes in data communication with each other via a network, each network node having a secure processing enclave, the enclave configured to include: at least one isolated memory device, processing logic isolated from operating system (OS) calls, and a remote attestation capability; and a wallet configured as executable code on a client device, the wallet including a view key and a spend key,
a non-transitory machine-useable storage medium embodying instructions which, when executed by a machine, cause the machine to: establish a secure data communication with at least one of the plurality of network nodes, the secure data communication being enabled after the enclave of the at least one of the plurality of network nodes is validated after completion of the remote attestation.

20. The non-transitory machine-useable storage medium of claim 19 wherein the client device is a mobile device.
